(19) United States
(12) Patent Application Publication
(10) Pub. No.: US 2006/0195366 A1
(43) Pub. Date: Aug. 31, 2006

(54) Granting greater rights to stored content

(76) Inventors: Richard M. Clayton, Phoenix, AZ (US); Michael T. Gaumond, Scottsdale, AZ (US); Jeffrey S. Stinson, Mesa, AZ (US); David E. Ulmer, Phoenix, AZ (US); Jean-Marc A. Villevieille, Phoenix, AZ (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/296,971

(22) Filed: Dec. 8, 2005

Related U.S. Application Data
(60) Provisional application No. 60/651,961, filed on Feb. 11, 2005.
(60) Provisional application No. 60/651,963, filed on Feb. 11, 2005.
(60) Provisional application No. 60/651,960, filed on Feb. 11, 2005.
(60) Provisional application No. 60/651,958, filed on Feb. 11, 2005.
(60) Provisional application No. 60/651,959, filed on Feb. 11, 2005.

(51) Int. Cl. G06Q 30/00

(52) U.S. Cl. 705/26; 705/16

(57) ABSTRACT

In a method for granting relatively greater rights to stored content, a target device is disconnected from a content service, content is played on the target device, and a purchase selection of the content is detected. In addition, an entry of the content purchase selection is logged and a characteristic of the content is modified to grant relatively greater rights to the selected content.

### PRIORITY

This application claims priority to U.S. Provisional Patent Application No. 60/651,961, filed on Feb. 11, 2005, and entitled, “SEAMLESS TRANSACTIONS ACROSS DOMAINS AND DEVICES,” to U.S. Provisional Patent Application No. 60/651,963, filed on Feb. 11, 2005, and entitled, “WIRELESS AUDIO ADAPTER FOR CAR RADIOS,” to U.S. Provisional Patent Application No. 60/651,960, filed on Feb. 11, 2005, and entitled, “ZERO INSTALL WIRELESS AUDIO ADAPTOR,” to U.S. Provisional Patent Application No. 60/651,958, filed on Feb. 11, 2005, and entitled, “DAILY SET WITH MULTIPLE CONTENT CHANNELS,” and to U.S. Provisional Patent Application No. 60/651,959, filed on Feb. 11, 2005, and entitled, “SUPPLEMENTING DAILY SET WITH HOT CONTENT”. The disclosures contained in all of the aforementioned provisional applications are hereby incorporated by reference in their entireties.

### RELATED APPLICATIONS

This application incorporates by reference in their entireties the following commonly assigned U.S. Utility Patent Applications: Serial No. TBD (Attorney Docket No BCS03806), entitled“HOTCONTENTUPDATEFORATARGETDEVICE”; SerialNo. TBD (Attorney Docket No BCS03803), entitled “WIRELESS ADAPTOR FOR CONTENT TRANSFER”; Serial No. TBD (Attorney Docket No BCS03805), entitled “AUTOMATIC CONTENT UPDATE FOR A TARGET DEVICE”; Serial No. TBD (Attorney Docket No BCS03802), entitled “WIRELESS ADAPTOR FOR CONTENT TRANSFER”

### BACKGROUND

Portable content players and other devices capable of playing content, such as media (music or videos), are becoming increasingly popular and are typically designed to play the personal content of users. Users tend to use multiple devices, such as an MP3 player, cellular phone, personal digital assistant, personal computer, and a car audio system, and many of these devices are capable as content players for playing the personal content of the users. However, there is currently no fast and convenient way to transfer content between the multiple devices. These devices tend to have different user interfaces, so it typically is inconvenient for a user to learn and operate each device to play music or other media. In addition, it is often difficult for users to maintain collections of structured content that is available across the multiple devices.

There has also been a relatively large growth in the number of companies that supply downloadable content for the portable music players and other devices. These companies often require that a user subscribe to their service or pay directly for purchased content received from these companies. The rights associated with content downloaded from these companies are relatively limited when the downloaded content is free and oftentimes when the user pays for the content. In addition, users typically cannot manipulate the downloaded files unless their devices are in communication with the websites of these companies, which is an inconvenience when the user does not have continuous access to a network, such as the Internet or a cellular network.

### SUMMARY

A method for granting relatively greater rights to stored content is disclosed. In the method, a target device is disconnected from a content service. In addition, content is played on the target device and a purchase selection of the content is detected. An entry of the content purchase selection is logged and a characteristic of the content is modified to grant relatively greater rights to the selected content.

### BRIEF DESCRIPTION OF THE DRAWINGS

Embodiments are illustrated by way of example and not limited in the following figure(s), in which like numerals indicate like elements, in which:

FIG. 1 illustrates a system for content distribution, according to an embodiment;

FIG. 2A illustrates an example of the system for content distribution shown in FIG. 1, according to an embodiment;

FIG. 2B illustrates an example of a target device shown in FIGS. 1 and 2A, according an embodiment;

FIG. 3 illustrates embodiments of a common user interface;

FIG. 4A illustrates a method, according to an embodiment;

FIG. 4B illustrates another method, according to an embodiment; and

FIG. 5 illustrates a computer system that may be used for components of a system, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

A target device configured to enable relatively greater rights to stored content, while the target device is disconnected from a content service, is disclosed herein. Also disclosed herein is a method for granting the relatively greater rights to the stored content while the target device is disconnected from the content service. In one regard, the examples disclosed herein generally enable a user to receive purchased content and make payment for the purchased content at a later time. In addition, the transaction may appear to have occurred through a fully connected system to the user, even though the target device was disconnected from the content service when the greater rights were afforded.

1. System Overview

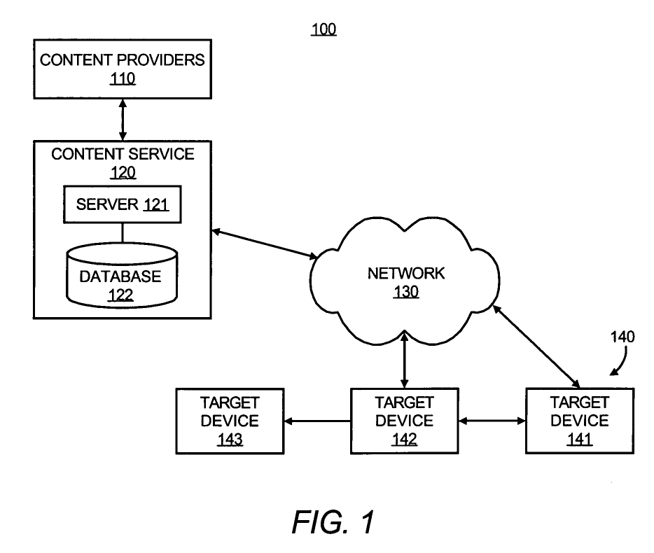

FIG. 1 illustrates a system 100 for content distribution according to an embodiment. The system 100 includes content providers 110, content service 120, network 130 and target devices 140. The content providers 10 include entities configured to provide content that may be played or otherwise consumed by users. Content may include: media, such as, audio, video, text; multimedia that includes two or more of audio, video and text; or other types of data. Examples of content include, but are not limited to, media files, such as MP3 files, other types of audio files, video files, textual music play lists, and other types of files. Examples of content providers 110 may include, but are not limited to, news providers (such as local and cable news television stations), television studios, movie studios, music labels, online music (or other media) providers, and others.

Generally speaking, the content providers 110 provide content to the content service 120, such that the content service 120 may provide several functions. One of the functions includes receiving new content from the content providers 110 on a substantially regular basis. Another of the functions includes making the content received from the content providers 110 available to users. In addition, the content service 120 may receive content from multiple content providers 110 to provide users with a relatively large content selection. Users may obtain the content made available by the content service 120 through, for instance, one or both of subscription services and on-demand services.

The content service 120 may also automatically organize content for users and continually provide new content to users. In addition, the content service 120 may perform other functions, such as billing, user information tracking, historical data tracking, etc. The content service 120 may include a server 121 and a database 122 for storing user information and content. The server 121 may facilitate the downloading of content to the target devices 140 used by the users. It will be apparent to one of ordinary skill in the art that the server 121 may include multiple servers and the database 122 may include multiple databases depending on the size and complexity of the content service 120. For example, to support a relatively large number of users, several servers 121 and databases 122 may be needed to harvest content from the content providers 110 and provide content to users with minimal delay.

The network 130 may represent one or more networks. The network 130 may include one or more of private networks, public networks, such as the Internet, wireless networks, such as satellite and cellular networks, and local area wireless networks, such as WiFi or Bluetooth networks, wired networks, local area networks, wide area networks, and any other type of communication network.

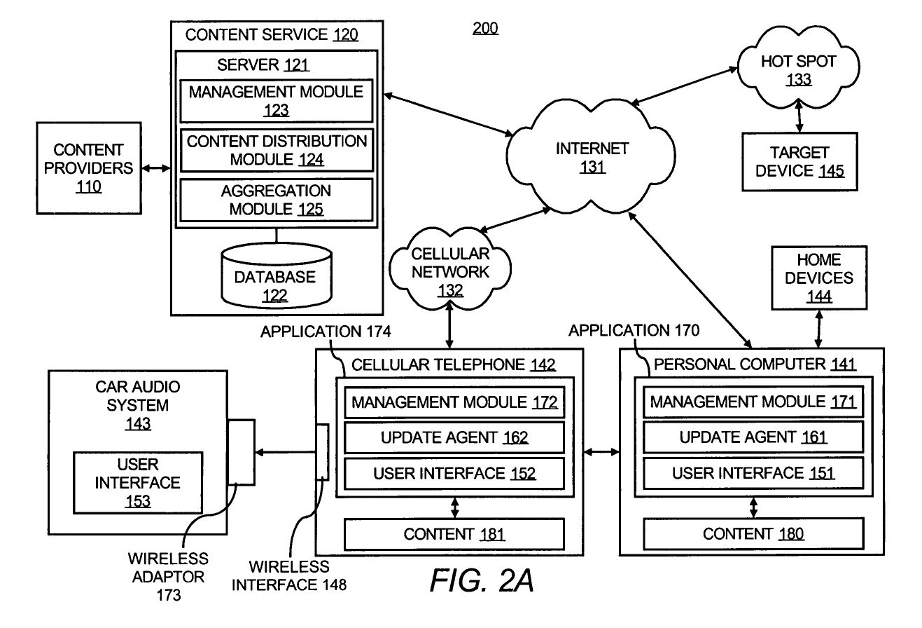

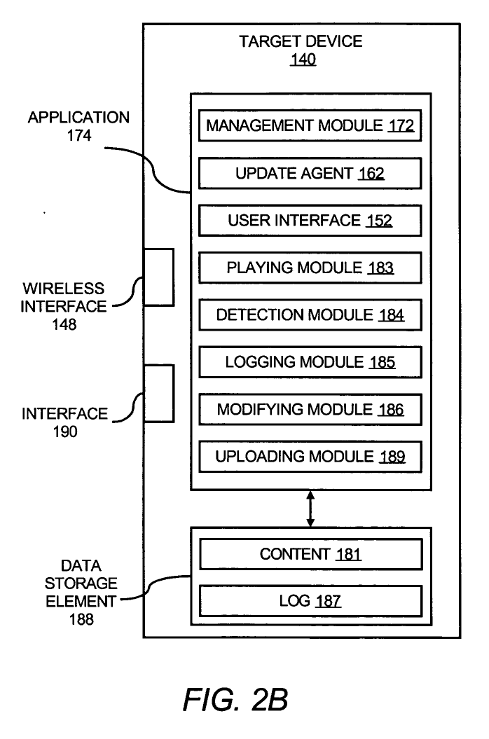

The content service 120 may provide content to the target devices 140 via the network 130. The target devices 140 may download the content from the content service 120, may receive content from another target device 140, such as, in a peer-to-peer arrangement, or may be operable to both download content from the content service 120 and receive content from another target device 140. For example, and as shown in FIG. 1, target devices 141 and 142 are operable to download content from the content service 120 and are operable to receive content from another target device 141, 142. As also shown in FIG. 1, the target device 143 is operable to receive content from another target device, such as the target device 142. In this example, the target device 142 may download content from the content service 120 and the target device 143 may receive the content from the target device 142. The content service 120 and target devices 140 are described in further detail with respect to FIGS. 2A and 2B. Examples of suitable target devices 140 include but are not limited to personal computers, personal digital assistants, cellular telephones, car radio, home stereos, set-top boxes, MP3 players, portable video players, and other end-user devices.

2. Overview of Functionality and Advantages of Content Service

The system 100 provides a media experience for users without requiring a user to change conventional behavior to utilize the content service 120 providing the media experience. For example, the system 100 allows a user to play his or her selected audio content, such as music stations, talk radio, personal content, etc., on one of several target devices 140 that the user may be using at any particular time, such as a car radio in the car, a cellular phone when the user is on the go, a personal computer or home stereo at home, etc. The target device 140 may carry content selected by the user in a set of channels which are seamlessly available throughout the day on any one of many target devices 140. The system 100 manages the content and ensures the content is automatically replenished as it is consumed. Furthermore, an interface that is the same as or similar to a conventional device interface may be provided on the target devices 140, so the user may play desired content on any target device 140 in a relatively quick and easy manner.

According to an embodiment, the content service 120 allows a user to configure one or more sets of channels for one or more target devices 140. Each channel is populated with content from a content provider or content provided by the user. A channel is a data set of content, which may be of a particular type of content. For example, the content service 120 may make available hundreds of stations of content (for instance, webcast radio stations) or individual pieces of content, based on the content received from the content providers 110. In one example, one or more stations provide large or continuous blocks of Digital Millennium Copyright Act (DMCA) compliant music content. Channels may include content of a particular type, such as a sports talk channel, a popular music channel, etc. A user may configure a set of channels (hereinafter referred to as a channel set), for example, by selecting content provided by the content service 120 and of interest to the user. The channels may include high-quality, digital content, which may be commercial-free in some instances. A channel in a channel set may also include content from a user's personal collection, such as audio files stored on the user's personal computer. This channel may be programmed by play list, genre, or artist, or any other desired category or set of content.

A user may configure several channel sets, such that the user may use different channel sets at different times. For example, a user may create a first channel set for everyday use, such as for commuting to work. This channel set may include a traffic and news channel, a sports talk radio channel, as well as other channels. The user may create a second channel set for long trips, which may include, for instance, a classic rock channel and a comedy channel.

Content for the channels may be downloaded to one or more of the target devices 140 from the content service 120. The content service 120 may also refresh a target device 140 with new content on a substantially continuous basis. For example, after content in a channel in a target device 140 is consumed by a user, such as after the content is played, or after content becomes stale, such as after a predetermined period of time has lapsed, the content in the channel may be replenished or replaced with new content received from the content service 120 or new content that was cached in another target device 140. This update of content on a target device 140 may be performed automatically, and may be beneficial for target devices 140 that have limited storage for storing content, such as a PDA, phone, or other device having a relatively small amount of storage space.

In addition, the target devices 140 may each include an interface that is similar or the same as a conventional user interfaces widely used in at least one type of today's end user devices. Thus, a user may not be required to learn how to use the interface of a target device 140. Furthermore, a common interface may be provided on several target devices 140 that may be used by a single user to play content. For example, the common interface may be provided on a user's phone, personal computer, car radio, etc. Thus, the user may not need to learn how to use different interfaces for different target devices 140.

The user interfaces of the target devices 140 may emulate or include the user interfaces of conventional radio or music players with channel presets. The interfaces on the target devices 140 may provide for “one-click” channel selection, similar to clicking a channel preset button on a radio. In one example, each channel may include content populated with a type or genre of music pre-selected by the user, which allows a user to switch with one click between channels similar to switching between different radio stations on a radio. The interface may also allow a user to fast forward, rewind, or pause content.

A relatively simple software application installed on a user's personal computer allows the user to manage and configure channel sets and update content on multiple target devices. Also, the content that is stored on one target device 140, may also be available on at least one other target device 140. Furthermore, the same software application or another software application may be provided on a target device 140 that allows a user to flag songs or other content and add them to a personal wish list for purchase as described in greater detail herein below.

3. Content Service

FIG. 2A illustrates an embodiment of the system 100 for content distribution. The content service 120 is shown as including a management module 123, a content distribution module 124, and an aggregation module 125, in addition to the server 121 and the database 122 discussed with respect to FIG. 1. As referred herein, a module includes one or more software programs, applications, or routines stored on a computer readable medium for execution by at least one processor. Embodiments of a computer readable medium may include, but are not limited to, an electronic, optical, magnetic, or other storage or transmission device capable of providing a processor in the receiver with computer-readable instructions. Other examples of a suitable computer readable medium include, but are not limited to, a floppy disk, CD-ROM, DVD, magnetic disk, memory chip, ROM, RAM, an ASIC, a configured processor, any optical medium, any magnetic tape or any other magnetic medium, or any other medium from which a processor can read instructions. In addition, or alternatively, a module may refer to hardware configured to perform one or more functions described herein. In addition, or alternatively, a module may refer to hardware configured to perform one or more functions described herein.

The management module 123 may coordinate information between multiple users. For example, the management module 123 may receive channel configuration information from multiple users, which may include user selections of content for channels in one or more sets of channels for the multiple users. The user selections and channel sets configured by the users, may be stored in the database 122 along with additional channel configuration information added by the content service 120, such as permissions and special attributes or rules for content consumption, that is related to the user selections and configurations. The database 122 is queried subsequently to determine the content to provide to the users. In one embodiment, the management module 123 generates a web based user interface which allows a user to log into the content service 120, register with the content service 120 and set preferences, and configure channel sets.

For example, a user connects to the content service 120 via the network 130 shown in FIG. 1, which may include the Internet 131 and/or other networks shown in FIG. 2, using a personal computer 141. The user provides user information to the content service 120, which is stored in the database 122. The management module 123 may prompt a user for channel configuration information, such as a selection of a content type for each channel. For example, the user may select news, traffic, and weather for channel 1, sports talk radio for channel 2, pop music for channel 3, alternative music for channel 4, classic rock music for channel 5, and classical music for channel 6. The management module 123 stores the user selections in the database 122, and channels 1-6 are populated with content corresponding to the associated user selections, and related channel configuration information added by the content service 120, using the content distribution module 124. It should be readily understood that six channels have been described above for purposes of illustration and not of limitation. Therefore, any reasonably suitable number of channels may be available for configuration without departing from a scope of the system 100.

Alternatively, the management module 123 may prompt the user for user information, and channels may be selected for the user based on the user information. For example, the user may provide demographic information or a selection of favorite artists. Several channels may be selected for a channel set for the user based on this information. The user may select some of the channels for a channel set. Default channels may also be provided. Also, several channel sets may be configured for each user.

The content distribution module 124 sends content for channel sets to one or more target devices 140. The content distribution module 124 may determine the content to send to the target devices based on the related selected channel configuration information. For example, the content distribution module 124 retrieves channel configuration information for a selected set of channels from the database 122. In addition, the content distribution module 124 may send content for the respective channels to one or more target devices 140.

The aggregation module 125 receives, for example, content and play lists from the content providers 110 and stores the information in the database 122, such that the content may be distributed to users as needed.

4. Personal Computer User Gateway for Content Service

Several target devices 140 are shown in FIG. 2A. The target devices 140 are shown as comprising a personal computer 141, a cellular telephone 142, a car audio system 143, and home devices 144. These are examples of some target devices 140 that may be used by a user. It will be apparent that other target devices 140 may also be used, such as portable content device (for instance, an MP3 player), vehicle audio systems, home media servers, etc.

Some of the target devices 140 shown in FIG. 2A are connected to the content service 120 via a network. For example, the personal computer 141 is depicted as being connected to the content service 120 via the Internet 131. The cellular telephone 142 is depicted as being connected to the content service 120 via a cellular network 132 and the Internet 131. In addition, a target device 145 is depicted as being connected to the content service 120 via a “hot spot” 133 and the Internet 131. Although not shown, additional target devices 140 may be connected to the content service 120 using one or more private networks, as opposed to a public network such as the Internet 131, and the content service 120 may provide a non-web-based content service. In one embodiment, the content service 120 includes a web service, which the user may log into using the personal computer 141 or another target device 140. In this embodiment, the content for the channels may be downloaded to one or more target devices 140 via the Internet 131.

The personal computer 141 may include an application 170 having a management module 171, an update agent 161, and a user interface 151. The management module 171 generally allows the user to determine and send channel configuration information for configuring selected channel sets to the content service 120. The channel configuration information may include the selection of content to place in the selected channel sets.

Examples of content that may be selected for a channel set may include genre-oriented music stations, talk content, the user's personal content, etc. Genre-oriented music content may be selected from a catalog listing a relatively large number of stations or individual content provided by the content providers 110. In addition, a single music channel may deliver a continuous set of music tracks on a target device 140. Talk content may also be selected from a catalog of talk content channels, which may be updated periodically, such as hourly, daily or weekly. In addition, content from more than one content provider may be placed in a single channel set. The user's personal content may be stored on the personal computer 141, which the management module 171 may discover. As such, a user may sort through various content in various manners and may move individual tracks of content or large blocks of content to a channel in a channel set.

The update agent 161 generally receives content from the content service 120 and may refresh content 180 stored on the personal computer 141 on a periodic basis. For instance, the update agent 161 caches the content 180 at the personal computer 141. The content 180 may include content received from the content distribution module 124 of the content service 120.

The update agent 161 also controls the transfer of content 180 to other target devices 140. For example, when the cellular telephone 142 is connected to or otherwise interfaces with the personal computer 141, content for one or more selected channel sets may be transferred to the cellular telephone 142. In one example, the transfer of content 180 may be performed as a substantially automatic feature when the cellular telephone 142 is connected to the personal computer 141, whereby the user does not need to issue a transfer command. The update agent 161 may control the transfer of content 180 to the cellular telephone 142, such that new content may be experienced from one or more play lists.

In addition, the update agent 161 may control the transfer of content 180 to generally enable the new content to be stored on the cellular telephone 142 while staying within the limitations of the cellular telephone's 142 storage capabilities. Thus, at least a portion of the content 180 may be stored on the cellular telephone 142, which is indicated as content 181. Similarly, home devices 144, such as a home stereo or set-top box, may also receive content 180 from the personal computer 141. Instead of a personal computer 141, a server, such as a home media server, or another device may be used to receive and cache content 180 from the content service 120, without departing from a scope of the system 200.

The personal computer 141 may also include a user interface 151 that provides for “one-click” selection of channels and emulates a conventional interface. In one embodiment, the user interface 151 includes a GUI interface that a user may click to control playback and to select a channel. In addition, or alternatively, the user interface 151 may include hardware, such as buttons, wheels, keys, etc.

5. Portable Content Device

A portable content device, such as the cellular telephone 142, PDA, mp3 player, and the like, may include an application 174 having a management module 172, an update agent 162, and a user interface 152. The management module 172 generally allows the user to determine and send channel configuration information for configuring selected channel sets to the content service 120, in manners similar to those described above with respect to the management module 171 of the personal computer 141. In certain instances, the management module 172 may be considered optional for the application 174, since management of the application 174 may be performed by the personal computer 141.

The update agent 162 of the cellular telephone 142 generally controls updating of the content 181, which may include new content received from the content service 120 via the cellular network 132 and the Internet 131, a wireless proximity network such as Bluetooth or Wi-Fi (802.11), or any combination thereof, as routed from the content service 120 or through the personal computer 141. For example, the content 181 may comprise new cached content received from the content service 120 as routed through the internet 131 and cellular network 132, as shown in FIG. 2. In another example, the content 181 may comprise new cached content received from the personal computer 141 via a wired connection or a wireless proximity network.

The update agent 162 of the cellular telephone 142 may also manage the receipt of content from one or both of the content service 120 and the personal computer 141. More particularly, for instance, the update agent 162 may control the receipt of one type of content from the content service 120 and another type of content from the personal computer 141. For example, the update agent 162 may control the receipt of content, such that, content required to be updated relatively frequently (hot content), such as traffic information, is received from the cellular network 132. In another example, the update agent 162 may control the receipt of content such that hot content is received from the personal computer 141 before such content expires (without going through the cellular network 132 or any other wireless telecommunication network). In addition, the update agent 162 may control the receipt of cold content, which are content that may be updated less frequently, to be received from the personal computer 141. In this example, the personal computer 141 may download the cold content from the content service 120. Furthermore, when the cellular telephone 142 is connected to or otherwise interfaces with the personal computer 141, the cold content may be updated on the cellular telephone 142. It will be apparent to one of ordinary skill in the art that cold content, such as music, may also be downloaded to the cellular telephone 142 via the cellular network 132.

The cellular telephone 142 is also depicted as including a wireless interface 148, which may be used to connect to the content service 120 via hot spots 133, the personal computer 141, other target devices 140, etc. The wireless network interface 148 may also be used to transfer content 181 to the car audio system 143, as shown in FIG. 2A.

Playback of the content 181 may be controlled via the user interface 152 of the cellular telephone 142. For example, the user interface 152 may include controls to enable the selection of a preset channel, to rewind, fast forward, pause, play, etc.

Although not shown, the cellular telephone 142 may comprise a device configured to provide the functionalities of multiple devices. For example, the cellular telephone 142 may include an MP3 player, PDA, camera, video player, etc.

With reference now to FIG. 2B, there is shown an example of a target device 140 configured to enable relatively greater rights to selected content to be afforded to a user of the target device 140 while the target device 140 is disconnected from a content service that provided the content to the target device 140. As shown, the target device 140 may include features in addition to the features of the cellular telephone 142 described herein above with respect to FIG. 2A. The target device 140 is shown as also including a playing module 183, a detection module 184, a logging module 185, and a modifying module 186. In addition, the target device 140 is also shown as including a log 187 in a data storage element 188, which is further illustrated as including the content 181.

The playing module 183 may be implemented to play the stored content 181. More particularly, for instance, the playing module 183 may include one or both of hardware and software, such as, for instance, an MP3 player, that enables the output of audio through the target device 140.

The detection module 184 may be implemented to detect the selection by a user to purchase selected content 181. More particularly, for instance, the detection module 184 may detect when a user selects to purchase content, which may include either some or all of the content, that is or has played on the target device 140. By way of example, the content 181 being played on the target device 140 may comprise a downloaded webcast, to which the user is afforded a relatively small amount of rights. These rights may include, for instance, the ability to play the content once and in a streaming fashion. In this example, the user may select to purchase a song being played to thereby gain greater rights to the song, for instance, the ability to play the song multiple times or on multiple devices. As described in greater detail herein below, the user may gain these greater rights while disconnected from the content service 120 that provided the content 181. That is, for instance, the user may be granted these greater rights without initially being required to make a payment for the greater rights.

In any regard, the detection module 184 may be implemented to detect activation of at least one of a purchase indicator physically located on the target device 140, a purchase indicator displayed on a display of the target device 140, a voice-activated purchase indicator, and the like. In the first instance, the purchase indicator may comprise, for instance, a “buy”, a “purchase”, etc., button physically located on the target device 140. In addition, or alternatively, the purchase indicator may comprise one or more buttons that have features in addition to indicating a purchase request. For example, a the purchase indicator may be activated when a button is depressed for a predetermined period of time, when a button pressed a predetermined number of times within a predetermined period of time, when a combination of buttons are pressed simultaneously, etc. In the second instance, the purchase indicator may comprise a user-selectable icon. In any of the examples above, a confirmation process may be performed upon detection of the purchase indicator being activated to substantially avoid unintended purchases.

The logging module 185 may be implemented to log the detected purchase selection of the stored content 181. More particularly, for instance, the logging module 185 may log information pertaining to the detected purchase selection, such as, for instance, the unique identification of the content being purchased in a log 187 of the data storage element 188. The logged information may be used to charge the user at a later time as described in greater detail herein below. In addition, the unique identification of the content may be used to determine, for instance, the title, artist, album, price, etc., of the selected content,

The modifying module 186 may be implemented to modify a characteristic of the selected content. More particularly, for instance, the modifying module 186 may modify a characteristic of the selected content to enable relatively greater rights to the selected content to be afforded while the target device 140 is disconnected from a content service 120 that provided the content 181 to the target device 140. In one example, the modifying module 186 may modify rules associated with the selected content to provide the relatively greater rights. In another example, the modifying module 186 may copy the selected content to another location in the data storage element 188 that enables the selected content to be played with the relatively greater rights. In yet another example, the modifying module 186 may enable a second version of the content to be playable on the target device 140. In this example, the second version may include the relatively greater rights, may have a relatively higher fidelity, etc.

The target device 140 may also include an uploading module 189 configured to upload information contained in the log 187 to the content service 120 when the target device 140 is connected to the content service 120. The uploading module 189 may upload the information when target device 140 is detected to be interfaced with the content service 120 through an interface 190 in a substantially automatic manner. By way of example, the uploading module 189 may automatically upload the information when the target device 140 interfaces with the personal computer 141 or when the target device 140 connects directly with the content service 140.

The content service 120 may charge a user account, which may include either or both of subscription services and on-demand services, for the purchased content based upon the information received from the target device 140. In addition, the content service 120 may download additional content related to the purchased content to the target device 140. The additional content may include, for instance, a relatively higher fidelity version of the purchased content, advertisements, album information, videos, concert information, etc.

6. Content Player and Wireless Adaptor

A portable content device such as the cellular telephone 142 may send content to a content player such as the car audio system 143 via the wireless interface 148 of the cellular phone 142. In addition, a wireless adaptor 173 may be used to enable communications between the cellular telephone 142 and the car audio system 143 for receiving content and for controlling playback of the content. Although the wireless adaptor 173 has been illustrated as forming a separate device from the car audio system 143, the wireless adaptor 173 may integrally formed with the car audio system 143 without departing from a scope of the wireless adaptor 173. In addition, or alternatively, a wired interface may be used to enable the communications between the cellular telephone 142 and the car audio system 143. The wireless adaptor 173 and the wireless interface 148 are further described in commonly assigned and copending U.S. patent application Ser. No. TBD, entitled “SYSTEM AND METHOD FOR WIRELESS ADAPTER FOR CONTENT TRANSFER,” which was incorporated by reference in its entirety above.

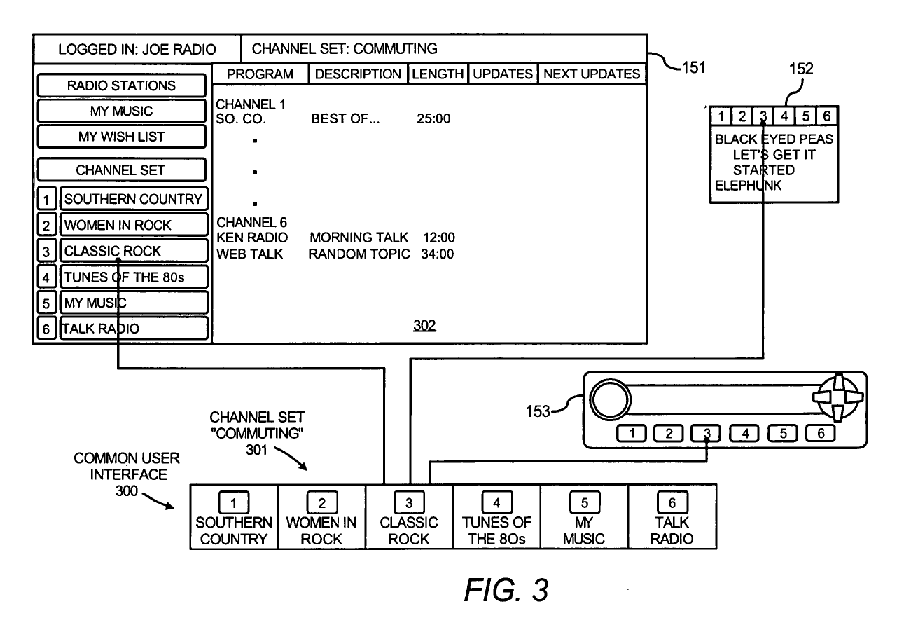

Although FIG. 3 and the description hereinafter refer to the portable content device as a cellular telephone 142, it should be understood that the cellular telephone 142 is used merely as an example, and any other portable content device may be used in its place. Examples of another portable content device include but are not limited to a digital music player and a PDA. Likewise, although FIG. 3 and the description hereinafter refer to a car radio component of a car audio system 143, it should be understood that such a car radio component is used merely as an example, and any other component in the car audio system 143 or any other content player may be used in its place. Examples of a component include but are not limited to a single CD player component, a CD changer component, and an auxiliary component. Examples of another content player include but are not limited to a marine audio system on a boat, a home audio system, and any other audio device or system

According to an embodiment, the cellular telephone 142 may wirelessly stream content 181 to the car audio system 143 via the wireless adaptor 173. In this regard, the content 181 stored on the cellular telephone 142 may be played through the car audio system 143. In other embodiments, the car audio system 143 may also include a video display (not shown) that may be employed to display content 181 containing video. In any regard, a user interface 153 of the car audio system 143 may be used to control playback of the content 181. For example, the user interface 152 may include controls to enable the selection of a preset channel, to rewind, fast forward, pause, play, etc.

7. Common User Interface

FIG. 3 illustrates embodiments of a common user interface 300 that may be provided in one or more of the target devices 140, such as the user interfaces 151-153 depicted in FIG. 2A. As shown, the user interfaces 151-153 may each include a common user interface 300. More particularly, the user interfaces 151-153 are depicted as including a common user interface 300 that includes a plurality of the same or similar features. In particular, each of the user interfaces 151-153 is depicted as including a set of presets “1-6”, each of which are mapped to a channel in a channel set.

As further depicted in FIG. 3, each of the user interfaces 151-153 includes the same preset mappings for each channel set. This is illustrated by the expanded view 301 of an example of presets for a channel set named “Commuting”. The presets 1-6 are shown as respectively being mapped to channels for “Southern Country”, “Women in Rock”, “Classic Rock”, “Tunes of the 80's”, “My Music”, and “Talk”. The mappings are the same for each of the user interfaces 151-153. For example, preset 3 is mapped to “Classic Rock” for all of the user interfaces 151-153. The same mappings for the user interfaces 151-153 applies for presets 1-2 and 4-6 also. In this regard, mappings may be determined for a plurality of channel sets and the mappings for each channel set may be the same on multiple target devices 140.

The presets generally provide “one-click-selection” of a channel to play content for the channel. Furthermore, because the mapping for the presets may be the same on each target device 140, the user is not required to relearn the mappings for each target device 140.

As shown, the user interface 151 may include buttons for “Radio Stations”, “My Music”, “My Wish List” and “My Channels”. Selection of the “Radio Stations” button may list radio stations provided by the content providers 110 shown in FIGS. 1 and 2 in a display section 302 of the user interface 151. The management module 171 shown in FIG. 2 may generate channel configuration information to include, for instance, user selections of radio stations provided by the content providers 110. The content from selected radio stations may further be provided in a channel selected by the user to include the selected content.

Selection of the “My Music” button may display a list of the user's personal content in the display section 302. Selection of the “My Wish List” button may display a list of the content selected for purchase. Selection of the “Channel Set” button may display the channels in a channel set, such as shown in the display section 302. For example, the title, description, and length of content may be displayed. Also, the updates and next updates may be displayed.

The user interface 152 is shown as including the presets 1-6. Also shown are the artist, title, and album for a track currently playing on the cellular phone 142. The user interface 153 is also depicted as including the presets 1-6 and other conventional interface buttons and a display. It will be apparent to one of ordinary skill in the art that the user interfaces 151-153 may include additional features and that some of the features shown may be removed without departing from a scope of the user interfaces 151-153. Furthermore, the user interfaces 151-153 may include a software interface, such as a GUI interface, a hardware interface, such as buttons on an audio system, portable end-user device or personal computer, or a combination of both hardware and software interfaces. In addition, information other than what is shown in FIG. 3 may be displayed in response to the selection of different options. For example, album art or video clips may be displayed for artists.

### 8. METHOD EXAMPLES

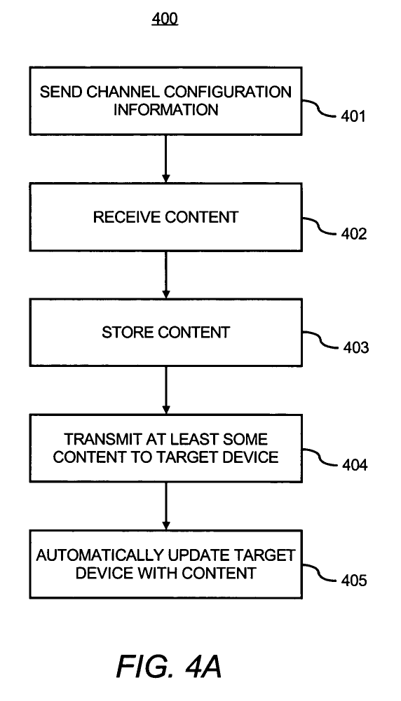

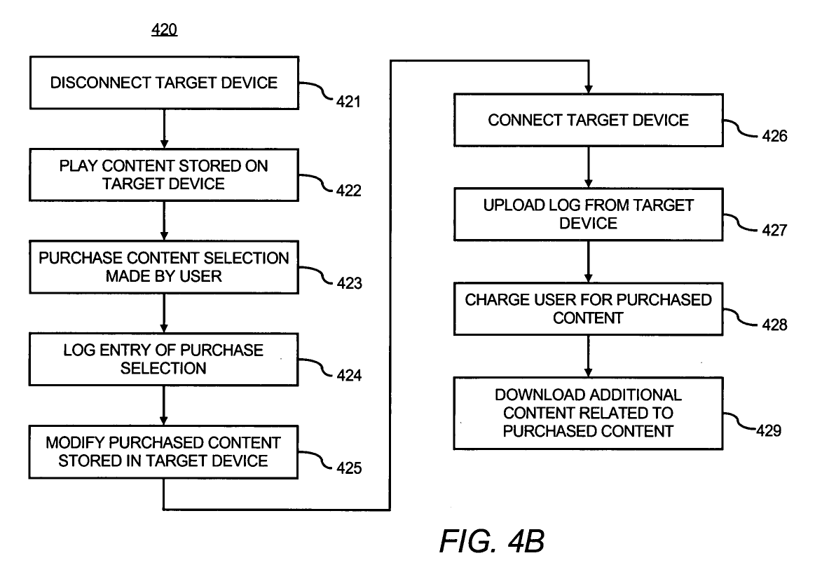

FIG. 4A illustrates a method 400 for automatically updating content at a target device 140. It is to be understood that the following description of the method 400 is but one manner of a variety of different manners in which examples of the systems 100 and 200 depicted in FIGS. 1-3 may be practiced. It should also be apparent to those of ordinary skill in the art that the method 400 represents a generalized illustration and that other steps may be added or existing steps may be removed, modified or rearranged without departing from a scope of the method 400.

The method 400 is described with respect to FIGS. 1-3 by way of example and not of limitation. It will thus be apparent to one of ordinary skill in the art, that the method 400 may be performed with systems other than those depicted in FIGS. 1-3.

At step 401, a target device 140, such as the personal computer 141 shown in FIG. 2, sends channel configuration information to the content service 120. The channel configuration information may include user selections of content for channels in one or more sets of channels. User selections may include selections of content provided by the content providers 110. Examples of content provided by the content providers 110 may include music, video and other media and data. In one example, content providers 110 may provide relatively large or continuous blocks of music or talk radio content. Several different categories of music and talk radio also may be provided. In this example, a user may select different categories of music or talk radio for different channels in a channel set. In other examples, the channel configuration information may include user demographic information and channels are selected for a user based on the user demographic information. Also, a channel or a channel set may include content from two or more categories, two or more content providers, or from a user's personal content.

At step 402, the personal computer 141 receives content for the channels in the one or more channel sets, and stores the content at step 403. At step 404, the personal computer 141 may transmit at least some of the content stored at the personal computer 141 to another target device 140, such as the cellular telephone 142. The amount and type of content transmitted to the target device 140 may be based, for instance, upon the storage capacity of the cellular phone 142 or other factors, such as, the amount of time elapsed from when a previous transmission of content occurred.

At step 405, the personal computer 141 may automatically update the content stored at the cellular telephone 142. For example, the cellular telephone 142 may connect to the personal computer 141 at various times to receive content. In this example, the personal computer 141 may receive a report from the cellular telephone 142 indicating the content that has been consumed and/or the content that is stale. In addition, or alternatively, the personal computer 141 or the server 121 may also determine what content is stale based upon, for instance, when the content was transferred to the cellular telephone 142. In response, the personal computer 141 may send content to the cellular telephone 142 to replace the consumed content and/or the stale content. In addition, or alternatively, the user may select the content in the cellular telephone 142 to replace with new content during the update, or the user may select to replace the entire content. Thus, the personal computer 141 may cache the content for updates or transmission to one or more other target devices 140. Alternatively, however, content may be sent from the content service 120 to a target device 140 other than the personal computer 141. For example, content, such as hot content, may be sent directly to the cellular telephone 142 from the content service 120 via the cellular network 132. In addition, although a single personal computer 141 has been discussed, the cellular telephone 142 may connect to multiple personal computers 141 without departing from a scope of the method 400.

FIG. 4B illustrates a method 420 for granting greater rights to content stored locally on a target device 140, while the target device 140 is disconnected from a content service 110. It is to be understood that the following description of the method 420 is but one manner of a variety of different manners in which examples of the systems 100 and 200 depicted in FIGS. 1-3 may be practiced. It should also be apparent to those of ordinary skill in the art that the method 420 represents a generalized illustration and that other steps may be added or existing steps may be removed, modified or rearranged without departing from a scope of the method 420.

The method 420 is described with respect to FIGS. 1-3 by way of example and not of limitation. It will thus be apparent to one of ordinary skill in the art, that the method 420 may be performed with systems other than those depicted in FIGS. 1-3.

At step 421, the target device 140, such as, a cellular telephone, a personal digital assistant, a digital music player, a car radio, a home stereo, a set-top box, and a digital video player, may be disconnected from a content service 120. In one example, the target device 140 may be disconnected from a relatively direct connection to the content service 120 through, for instance, a cellular network 132. In another example, the target device 140 may be disconnected from a relatively indirect connection to the content service 120, through, for instance, a connection with a gateway to the content service 120, such as, a personal computer 141 configured to receive content from the content service 120. In any case, the target device 140 may be disconnected from communicating with the content service 120 at step 421.

At step 422, content 181 stored on the target device 140 may be played on the target device 140. The content 181 may comprise, for instance, audio and video webcast content, photo albums, written text, such as books, magazines, news articles, comic books, etc., and the like. In addition, the content 181 may have been stored on the target device 140 through, for instance, operation of the method 400.

At step 423, the detection module 184 may detect a selection to purchase content 181, as described above with respect to FIG. 2B. In addition, at step 424, the detected content purchase selection may be logged in a data storage element 188 of the target device 140.

At step 425, the modifying module 186 may modify a characteristic of the content to grant relatively greater rights to the selected content. In one example, the modifying module 186 (shown in FIG. 2B) may enable a relatively higher fidelity version of the selected content to be playable on the target device 140. In this example, the relatively higher fidelity version may have been stored on the target device 140 along with the relatively lower fidelity version during, for instance, performance of the method 400. In addition, the relatively higher fidelity version may have been inaccessible to the user until the user selects to purchase the content.

In another example, the modifying module 186 may enable the selected content to be played multiple times on the target device 140. As described in greater detail herein above, in this example, the modifying module 186 (shown in FIG. 2B) may change rules associated with the selected content, may move the selected content to a different folder in the data storage element 188, etc. As another example, the modifying module 186 may modify the selected content such that the selected content may be copied onto and played on another target device 140.

At step 426, the target device 140 may be connected such that the target device 140 is in communication with the content service 120. More particularly, for instance, at step 426, the target device 140 may be connected to a gateway to the content service 120, such as, a personal computer 141 configured to receive content from the content service 120. In addition, or alternatively, the target device 140 may be substantially directly connected to the content service 120 through, for instance, a cellular network 132.

In either event, the uploading module may upload the logged information pertaining to the selected content purchase to the content service 120, as indicated at step 427. The uploading of the information may be performed substantially automatically by the uploading module 188 when a connection with either or both of the personal computer 141 and the content service 120 is detected. In one example, the personal computer 141 may store the logged information from the upload module 188 and may upload the logged information to the content service 120 at a later time, for instance, if the personal computer 141 is not connected to the content service 120 at that time.

At step 428, the content service 120 may charge the user account, which may comprise either or both of a subscription account and an on-demand account, for the selected content purchase. As such, the purchase transaction for the selected content may be completed.

Optionally, however, the content service 120 may download additional content related to the purchased content, as indicated at step 429. By way of example, the additional content may include, content with different digital rights management, content having a different codec version, a higher fidelity version of the purchased content, advertisements, album information, videos, concert information, featured songs, etc.

9. Hardware Platform

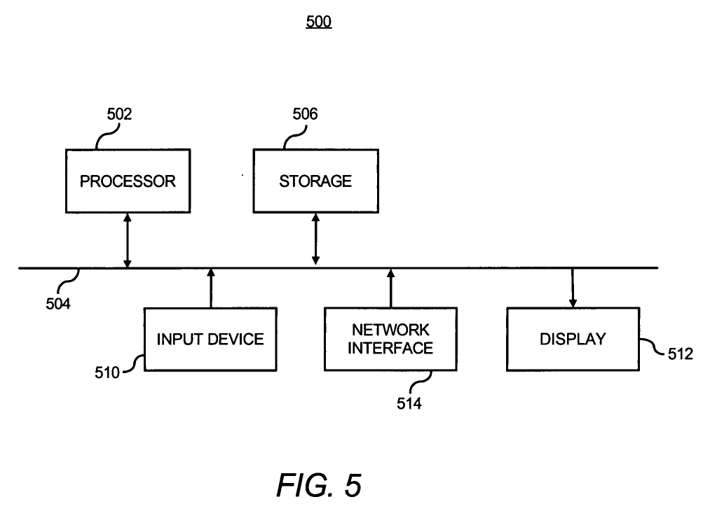

FIG. 5 illustrates a block diagram of a computer system 500 which may be used as a hardware platform for one or more of the components of the system 100, such as the personal computer 141, server 121, cellular telephone 142, as well as one or more of the other components depicted in FIGS. 1-3. The computer system 500 is a simplified block diagram, and the components of the system 100 may include many more elements not shown or some of the components may not include all the elements shown in FIG. 5.

The computer system 500 may include a processor 502, which provides a platform for executing software. The computer system 500 also includes a storage 506, which may include Random Access Memory (RAM) where software is resident during runtime. The storage 506 may also include one or more other types of memory such as ROM (read only memory), EPROM (erasable, programmable ROM), EEPROM (electrically erasable, programmable ROM) and data storage, such as hard disks, etc., may be used. For example, the storage 506 may include one or more hard disk drives and a removable storage drive, such as a floppy or flash memory.

A user may interface with the computer system 500 through an input device 510, such as, a keyboard, buttons, a mouse, a stylus, and the like. A display 512 and a network interface 514 may also be included. In addition, the processor 502 may communicate with one or more of the components depicted in FIG. 5 over a network, for instance, the Internet, LAN, etc., through a network adaptor 504.

One or more of the steps of the method 400 and other steps described herein and software described herein may be implemented as software embedded or stored on a computer readable medium, such as the storage 506, and executed by the processor 502. The steps may be embodied by a computer program, which may exist in a variety of forms both active and inactive. For example, there may exist as software program(s) comprised of program instructions in source code, object code, executable code or other formats for performing some of the steps when executed. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method comprising:
disconnecting a target device from a content service;
playing content on the target device;
detecting a purchase selection of the content;
logging an entry of the content purchase selection; and
modifying a characteristic of the content to grant relatively greater rights to the selected content.

2. The method according to claim 1, wherein disconnecting the target device from the content service further comprises disconnecting the target device from at least one of a personal computer and a cellular network, wherein the at least one of the personal computer and the cellular network is connected to the content service.

3. The method according to claim 1, wherein playing content on the target device further comprises playing a downloaded webcast on the target device.

4. The method according to claim 1, wherein the target device comprises at least one of a cellular telephone, a personal digital assistant, a digital music player, a car radio, a home stereo, a set-top box, and a digital video player, and wherein detecting a purchase selection of the content further comprises detecting activation of at least one of a purchase indicator physically located on the target device and a purchase indicator displayed on a display of the target device.

5. The method according to claim 1, wherein logging an entry of the content purchase selection further comprises logging the content purchase selection in a data storage element of the target device.

6. The method according to claim 1, wherein modifying a characteristic of the content further comprises modifying a characteristic of the content to at least one of enable the content to be played multiple times on the target device and enable the content to be played on another target device.

7. The method according to claim 1, further comprising:
downloading a first content at a first fidelity and a second content at a second fidelity from the content service prior to disconnecting the target device from the content service,
wherein the first fidelity is lower than the second fidelity; and
wherein playing content on the target device comprises playing the first content, and wherein modifying a characteristic of the content further comprises enabling play of the second content at the second fidelity.

8. The method according to claim 1, further comprising:
connecting the target device to the content service;
uploading the logged entry of the content purchase selection to the content service; and
charging a user for the purchased content.

9. The method according to claim 8, wherein connecting the target device to the content service further comprises connecting the target device to a second target device, and wherein uploading the logged entry of the content purchase comprises uploading the logged entry of the content purchase to the second target device, and uploading the logged entry from the second target device to the content service when the second target device is connected to the content service.

10. The method according to claim 8, wherein connecting the target device to the content service further comprises connecting the target device to the content service through at least one of a cellular network and a WiFi network.

11. The method according to claim 8, wherein connecting the target device to the content service further comprises connecting the target device to a second target device connected to the content service, the method further comprising:
automatically uploading the logged entry of the content purchase selection to the content service in response to connection of the target device to the second target device.

12. The method according to claim 8, further comprising:
downloading additional content related to the purchased content from the content service to the target device.

13. The method according to claim 12, wherein downloading additional content related to the purchased content further comprises downloading a relatively higher fidelity version of the purchased content.

14. The method according to claim 12, wherein downloading additional content related to the purchased content further comprises downloading at least one of advertisements, album information, and videos.

15. A target device comprising:
a data storage element for storing content;
a module for playing the stored content;
a module for detecting a purchase selection of the stored content being played;
a module for logging a detected purchase selection of the stored content; and
a module for modifying a characteristic of the content, wherein the module for modifying is configured to modify a characteristic of the content to afford relatively greater rights to the selected content while the target device is disconnected from a content service that provided the content to the target device.

16. The target device according to claim 15, wherein the target device comprises at least one of a cellular telephone, a personal digital assistant, a digital music player, a car radio, a home stereo, a set-top box, and a digital video player.

17. The target device according to claim 15, further comprising:
a module for uploading the detected purchase selection logged by the module for logging; and
an interface for enabling communications between the target device and at least one of a personal computer configured for connection to a content service and a network configured for connection to a content service, wherein the interface is configured to upload the detected purchase selection of the content stored in the log when a connection between at least one of the personal computer and the network and the content service is made.

18. A system comprising:
a content service for providing content supplied by at least one content provider; and
a target device for receiving and storing the content provided by the content service, said target device being configured to enable relatively greater rights to be afforded to the content stored on the target device, while the target device is disconnected from the content service.

19. The system according to claim 18, wherein the target device comprises a module for detecting a selection to purchase the stored content, a module for logging a detected purchase selection, and a module for modifying a characteristic of the content to afford the relatively greater rights to the selected content, while the target device is disconnected from the content service.

20. The system according to claim 19, wherein the content service is further configured to charge a user of the target device for the selected content purchase.

21. The system according to claim 20, wherein the content service is further configured to download additional content related to the purchased content to the target device.

22. The system according to claim 18, further comprising:
a second target device in communication with the content service, wherein the target device is configured to connect to the second target device to thereby communicate with the content service.

23. A system comprising:
means for playing content;
means for detecting a purchase selection of the content;
means for logging an entry of the content purchase selection; and
means for granting relatively greater rights to the selected content, while the means for playing content is disconnected from a content service that provided the content to the means for playing.

24. A computer readable medium storing one or more computer programs including instructions that when executed perform the following:
play content on a target device;
detect a purchase selection of the content;
log an entry of the content purchase selection; and
modify a characteristic of the content, while the target device is disconnected from a content service that provided the content to the target device, wherein modification of the content characteristic grants relatively greater rights to the selected content.
